(19) United States
(12) Patent Application Publication
(10) Pub. No.: US 2002/0087442 A1
(43) Pub. Date: Jul. 4, 2002

(54) Method and apparatus for determining patent license fees

(76) Inventor: Scot A. Reader, Sherman Oaks, CA (US)

Correspondence Address: Scot A. Reader, Esq., 3424 Woodcliff Road, Sherman Oaks, CA, 91403, US

(21) Appl. No.: 09/752,471

(22) Filed: Jan. 2, 2001

(51) Int. Cl. G06F 17/60

(52) U.S. Cl. 705/31

(57) ABSTRACT

Method and apparatus for determining patent license fees improves rationality in fee determination by overcoming information and automation obstacles. The method and apparatus use, in one aspect, a licensee's patenting activity in a technological field as a proxy for the licensee's sales activity in the field and, in another aspect, make the fee determinations in a computer-database environment.

### BACKGROUND OF THE INVENTION

A fee for a unilateral patent license in a technological field may be calculated by multiplying the licensor's patent count in the field by the licensee's product revenue in the field and a “per patent” royalty rate. A fee for a unilateral patent license in multiple technological fields may be calculated by summing the fees calculated as described above for the individual fields. A fee for a bilateral patent license may be calculated by performing one of the foregoing calculations, swapping the licensor and licensee, repeating the one of the foregoing calculations and subtracting the fee calculated in the second instance from the first.

A licensor faces two obstacles in attempting to apply the foregoing formulas. The first obstacle is a lack of information. Patent counts are often available from public sources But while product revenue information across all technological fields, i.e. “global” product revenue information, is often available from public sources, such as securities filings, product revenue breakdowns for individual fields are not often available.

The second obstacle is a lack of adequate automation. Even if the licensor obtains all the information necessary to apply the foregoing formulas, there is a substantial cost associated with applying such information.

These twin obstacles to making rational fee determinations can hinder a patent licensing program at nearly every stage. They cloud judgments as to which licensees to pursue, in what order to pursue them, and what offers to make to them.

### SUMMARY OF THE INVENTION

In one aspect, the present invention facilitates rational patent license fee determinations by using a licensee's patenting activity in a technological field as a proxy for the licensee's sales activity in the field. An exemplary method comprises: determining licensor patent data in a technological field; estimating licensee revenue data in the field as a function of licensee patent data; and determining patent license fee data as a function of the licensor patent data and the licensee revenue data. The licensee revenue-estimating step is accomplished, in a preferred embodiment, by multiplying global licensee revenue data by a fraction having licensee patent data in the technological field for a numerator and global licensee patent data for a denominator. By using the fraction of the licensee's patent activity attributable to the technological field as an approximation of the licensee's sales activity attributable to the field, information that cannot often be learned from a public source, namely the licensee's product revenue data in the field, may be estimable using information that can often readily be learned from a public source, namely the licensee's patent data in the field. A substantial obstacle to rational patent license fee determinations, namely, the dearth of published product revenue by technological field, is thereby overcome.

In another aspect, the present invention facilitates rational patent license fee determinations through improved automation. An exemplary method comprises: inputting on a computer input data including a patent licensee identifier; processing using the computer the input data to calculate patent license fee data, including querying a database to generate data applied in calculating the patent license fee data; and outputting on the computer the patent license fee data. Preferably, the query-generated data include patent and revenue data. Performing patent license fee determinations in such a computer/database environment overcomes another substantial obstacle to rational patent licensing determinations, namely, the lack of adequate automation.

In another aspect, the benefits of improved automation are furthered by allowing the user to input on the computer additional input data, including license type, e.g. unilateral or bilateral, one or more technological fields, and one or more licensee identities, and by outputting on the computer patent license fee data corresponding to the input data.

These and other objects of the present invention may be better understood by reference to the following detailed description, taken in conjunction with the accompanying drawings briefly described below. Of course, the actual scope of the invention is defined by the appended claims.

### BRIEF DESCRIPTION OF THE DRAWINGS

FIG. 1 illustrates a client-server environment for use in automated determination of patent license fees;

FIG. 2 is a flow diagram illustrating a method for determining a unilateral patent license fee for a single technological field;

FIG. 3 is a flow diagram illustrating a method for determining a unilateral total patent license fee for multiple technological fields;

FIG. 4 is a flow diagram illustrating a method for determining a bilateral patent license fee for a single technological field;

FIG. 5 is a flow diagram illustrating a method for determining a bilateral net patent license fee for multiple technological fields;

FIG. 6 is a flow diagram illustrating a method for determining multiple unilateral patent license fees for a single technological field with licensee rank-ordering; and

FIG. 7 is a flow diagram illustrating a method for determining multiple unilateral total patent license fees for multiple technological fields with licensee rank-ordering.

### DETAILED DESCRIPTION OF THE PREFERRED EMBODIMENT

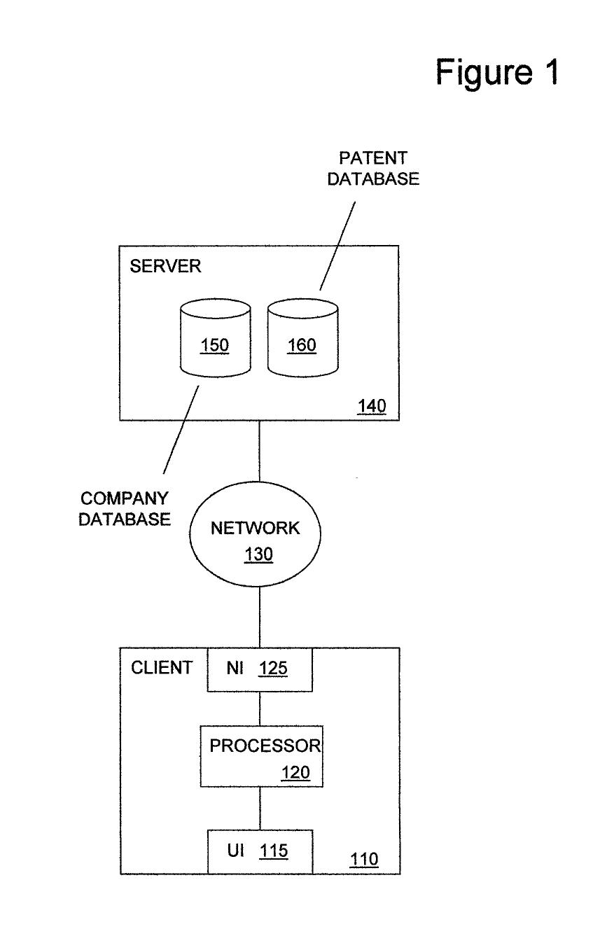

In FIG. 1, a client-server environment for use in automated patent license fee determination is shown. The environment includes client 110, such as a personal computer or workstation, having user interface 11 5, processor 120 and network interface 125. Client 110 receives and transmits data on user interface 115, processes data using processor 120 and exchanges data with server 140 over network interface 125. The client-server data exchanges are performed via network 130, such as a LAN or WAN, and involve retrieving information from company database 150 and patent database 160. The retrieved data are applied by processor 120 in calculating patent license fees. Company database 150 has entries for possible licensors and licensees including names of affiliated legal entities and global revenue data. Patent database 160 has entries for patents including patent numbers, assignee names, grant dates, maintenance status data and patent classification numbers. The patent classification numbers may be international classification numbers or U.S. classification numbers.

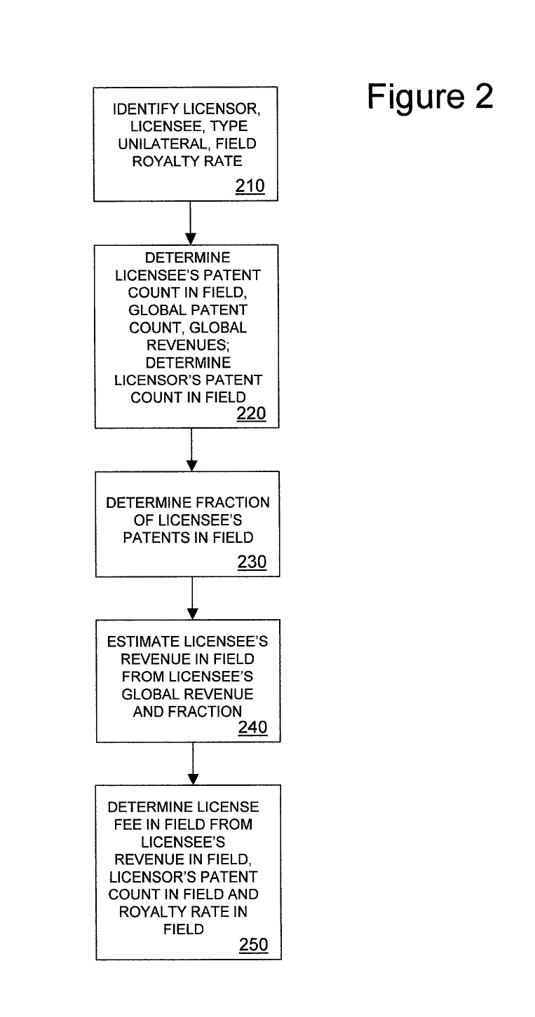

In FIG. 2, a flow diagram illustrates a method for determining a unilateral patent license fee for a single technological field. As applied within the client-server environment of FIG. 1, a user of client 110 is prompted via user interface 115 to identify a licensor, licensee, license type, technological field and a royalty rate. The user inputs the requested information on user interface 115 and selects type unilateral (210). The technological field may be input in the form of a patent classification number. Processor 120 forms licensor and licensee company search queries for company database 150 based on the licensor identity and the licensee identity, respectively, and the respective company search queries are transmitted over network 130 from client 110 to server 140 via network interface 125. At server 140, the respective company search queries are applied to company database 150 to generate respective company search results, including respective names of affiliated legal entities and, for the licensee, global revenue data. The respective company search results are transmitted from server 140 to client 110 via network 130 and network interface 125. At client 110, processor 120 forms licensor and licensee patent search queries for patent database 160 based on the respective names of affiliated legal entities from the respective company search results and the technological field. The respective patent search queries are transmitted from client 110 to server 140 via network 130 and network interface 125. If the technological field was not input in the form of a patent classification number, processor 120 replaces the technological field with one or more corresponding patent classification numbers in forming the respective patent search queries. At server 140, the respective patent search queries are applied to patent database 160 to generate respective patent search results, including respective patent counts within the corresponding patent classifications for which the licensor- and licensee-affiliated legal entities, respectively, are named as an assignee and additionally, for the licensee-affiliated legal entities, a global patent count. The respective patent search results are transmitted from server 140 to client 110 via network 130 and interface 125. Step 220 is thereby completed. At client 110, processor 120 divides the patent classification-based patent count for the licensee-affiliated legal entities by the global patent count for the licensee-affiliated legal entities to calculate the fraction of the licensee's global patent count attributable to the technological field (230) and multiplies the global revenue data for the licensee by the fraction to estimate the licensee's revenue attributable to the technical field (240). Processor 120 multiplies the licensee's estimated revenue in the technological field by the licensors patent count in the field and a royalty rate for the technological field to determine the license fee (250). The license fee is supplied as an output to the user on user interface 115. Naturally, the multiplication and division operations related above with respect to steps 230 through 250 may be performed in a different order within the scope of the invention. Moreover, while the foregoing method has been described as operating within the client-server environment of FIG. 1, the method is not limited to the such environment and may be performed using a combination of human and machine calculation. Whenever performed using machine calculation, an override option is preferably provided that allows the user to manually input patent and revenue data applied in the machine calculations of steps 230 through 250. By way of example, the licensor may input the licensor's patent count in the technical field. Reciprocally, whenever performed using machine calculation, a default option is preferably provided that allows the user to defer to a machine selected default for licensor, licensee, technological field and royalty rate. By way of example, the user may defer to a default selection of its client or employer as the licensor. It will also be appreciated that the description of data as being “global” is solely intended to distinguish such data from data that apply to fewer than all technological fields or patent classifications.

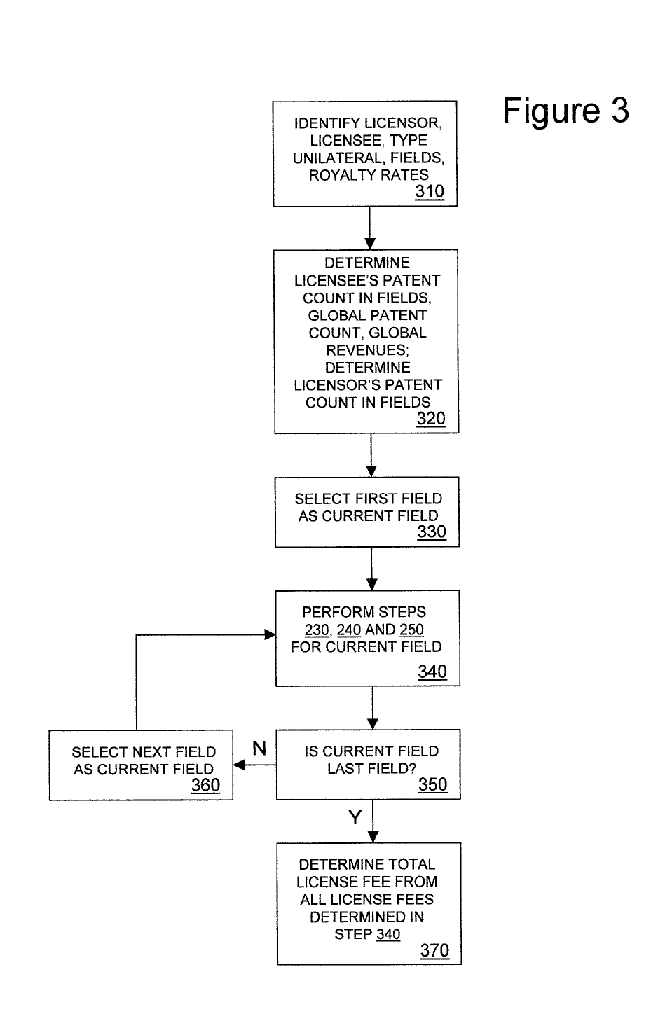

Turning now to FIG. 3, a flow diagram illustrates a method for determining a unilateral patent license fee in multiple technological fields. As applied within the client-server environment of FIG. 1, a user of client 110 is prompted to identify a licensor, licensee, license type, technological field and a royalty rate. The user inputs the requested information and selects type unilateral, only this time the user identifies multiple technological fields and corresponding royalty rates (310). The licensee's patent count in the technological fields, the licensee's global patent count, the licensee's global revenues and the licensor's patent count in the fields are determined by querying company database 150 and patent database 160 (320). The first technological field is selected (330) and Steps 230 through 250 as described above are applied to calculate a license fee for the first technological field (340). The second and subsequent technological fields are then selected in turn and Steps 230 through 250 are repeated for each field (350, 360). The license fees calculated for the multiple technological fields are summed to produce a total license fee (370) supplied as an output to the user.

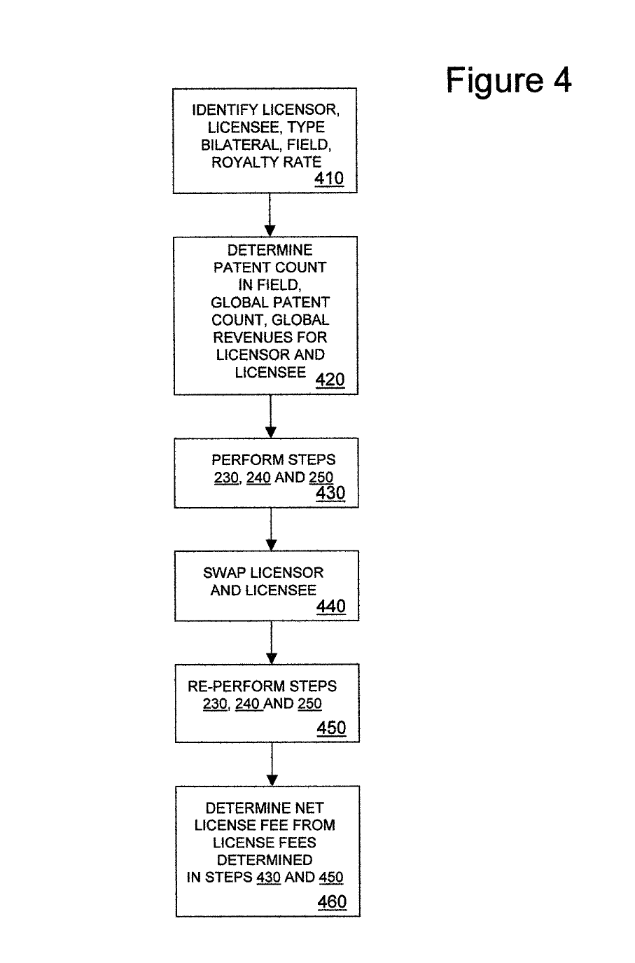

Turning next to FIG. 4, a flow diagram illustrates a method for determining a bilateral patent license fee in a single technological field. As applied within the client-server environment of FIG. 1, a user of client 110 is prompted to identify a licensor, licensee, license type, technological field and a royalty rate. The user inputs the requested information, only this time the user selects type bilateral (410). The licensor and licensee's patent counts in the technological field, the licensor and licensee's global patent count and the licensor and licensee's global revenues are determined by querying company database 150 and patent database 160 (420). Steps 230 through 250 as described above are applied to calculate a license fee for the licensor's grant to the licensee (430). The licensor and license are then swapped (440) and Steps 230 through 250 are repeated to calculate a license fee for the licensee's reciprocal grant to the licensor (450). The license fee for the reciprocal grant is subtracted from the license fee for the licensor's grant to the licensee to produce a net license fee (460) supplied as an output to the user.

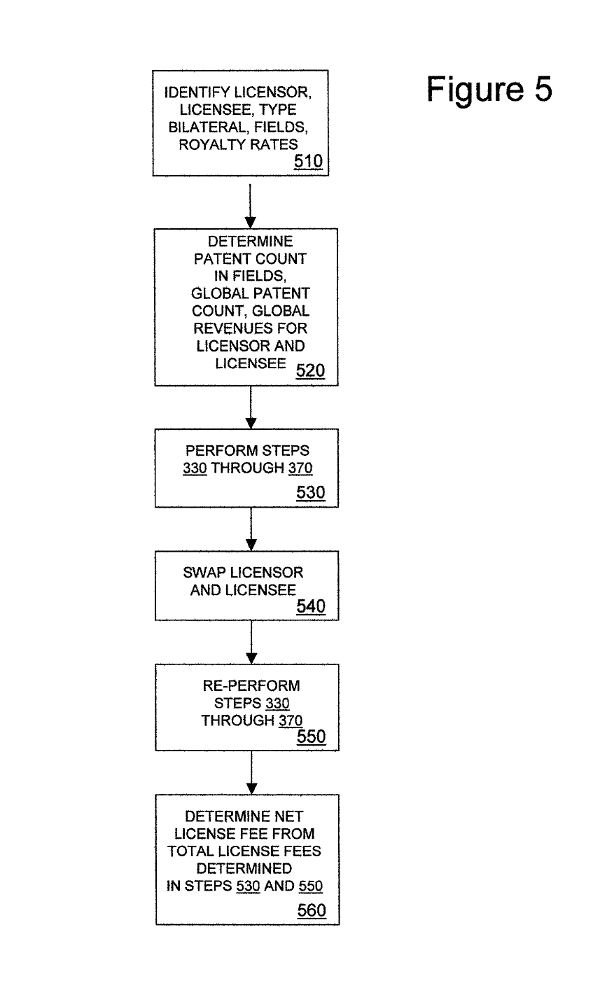

Turning next to FIG. 5, a flow diagram illustrates a method for determining a bilateral patent license fee in multiple technological fields. As applied within the client-server environment of FIG. 1, a user of client 110 is prompted to identify a licensor, licensee, license type, technological field and a royalty rate. The user inputs the requested information, only this time the user selects type bilateral and identifies multiple technological fields and corresponding royalty rates (510). The licensor and licensee's patent counts in the technological fields, the licensor and licensee's global patent count and the licensor and licensee's global revenues are determined by querying company database 150 and patent database 160 (520). Steps 330 through 370 as described above are applied to calculate a license fee for the licensor's grant to the licensee (530). The licensor and license are then swapped (540) and Steps 330 through 370 are repeated to calculate a license fee for the licensee's reciprocal grant to the licensor (550). The license fee for the reciprocal grant is subtracted from the license fee for the licensor's grant to the licensee to produce a net license fee (560) supplied as an output to the user.

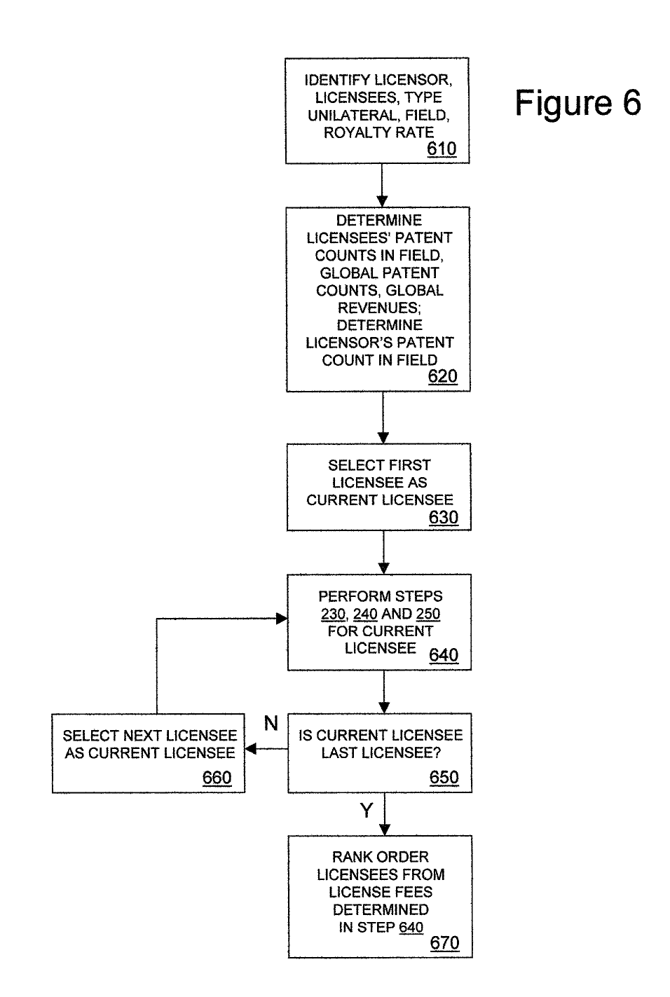

Turning next to FIG. 6, a flow diagram illustrates a method for determining multiple unilateral patent license fees in a single technological field with rank-ordering of licensees. As applied within the client-server environment of FIG. 1, a user of client 110 is prompted to identify a licensor, licensee, license type, technological field and a royalty rate. The user inputs the requested information, only this time the user identifies multiple licensees (610). The licensees' patent counts in the technological field, the licensees' global patent counts, the licensees' global revenues and the licensor's patent count in the field are determined by querying company database 150 and patent database 160 (620) The first licensee is selected (630) and Steps 230 through 250 as described above are applied to calculate a license fee for the first licensee (640). The second and subsequent licensees are then selected in turn and Steps 230 through 250 are repeated for each licensee (650, 660). The license fees calculated for the different licensees are rank-ordered to produce a hierarchical listing of licensees and corresponding license fees (670) supplied as an output to the user.

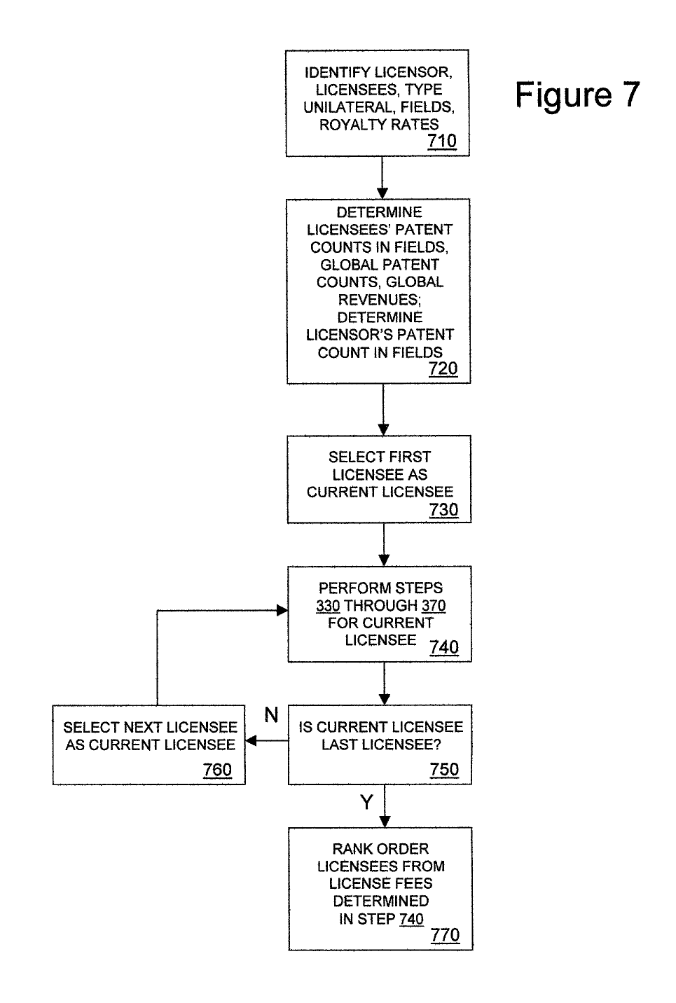

Turning finally to FIG. 7, a flow diagram illustrates a method for determining multiple unilateral patent license fees in multiple technological fields with rank-ordering of licensees. As applied within the client-server environment of FIG. 1, a user of client 110 is prompted to identify a licensor, licensee, license type, technological field and a royalty rate. The user inputs the requested information, only this time the user identifies multiple licensees and multiple technological fields and corresponding royalty rates (710). The licensees' patent counts in the technological fields, the licensees' global patent counts, the licensees' global revenues and the licensor's patent count in the fields are determined by querying company database 150 and patent database 160 (720). The first licensee is selected (730) and Steps 330 through 370 as described above are applied to calculate a license fee for the first licensee (740). The second and subsequent licensees are then selected in turn and Steps 330 through 370 are repeated for each licensee (750, 760). The license fees calculated for the different licensees are rank-ordered to produce a hierarchical listing of licensees and corresponding license fees (770) supplied as an output to the user.

It will be appreciated by those of ordinary skill in the art that the invention can be embodied in other specific forms without departing form the spirit or essential character hereof. The present description is therefore considered in all respects illustrative and not restrictive. The scope of the invention is indicated by the appended claims, and all changes that come within the meaning and range of equivalents thereof are intended to be embraced therein

I claim:

1. A method for determining a patent license fee, comprising the steps of:
determining licensor patent data in a technological field;
estimating licensee revenue data in the technological field as a function of licensee patent data; and
determining patent license fee data as a function of the licensor patent data and the licensee revenue data.

2. The method according to claim 1, wherein the licensee patent data includes licensee patent data in the technological field and global licensee patent data.

3. The method according to claim 1, wherein the licensee revenue data estimating step includes multiplying global licensee revenue data by the licensee patent data.

4. The method according to claim 1, wherein the licensor patent data includes a patent count in a patent classification.

5. The method according to claim 1, wherein the licensee patent data includes a patent count in a patent classification.

6. The method according to claim 1, wherein the patent license fee data determining step includes multiplying the licensor patent data, the licensee revenue data and a royalty rate.

7. The method according to claim 1, further comprising the steps of:
repeating the steps for a second technological field; and
summing the patent license fee data determined in the two instances to produce total patent license fee data.

8. The method according to claim 1, further comprising the steps of:
repeating the steps with the licensor and licensee reversed; and
subtracting the patent license fee data determined in the second instance from the patent license fee data determined in the first instance to produce net patent license fee data.

9. The method according to claim 7, further comprising the steps of:
repeating the steps with the licensor and licensee reversed; and
subtracting the total patent license fee data determined in the second instance from the total patent license fee data determined in the first instance to produce net patent license fee data.

10. The method according to claim 1, further comprising the steps of:
repeating the steps for a second licensee; and
rank-ordering the patent license fee data determined in the two instances.

11. The method according to claim 7, further comprising the steps of:
repeating the steps for a second licensee; and
rank-ordering the patent license fee data determined in the two instances.

12. The method according to claim 1, wherein the steps are performed using a computer.

13. An automated method for determining a patent license fee, comprising:
inputting on a computer input data including a licensee identity;
processing the input data using the computer to determine patent license fee data, including querying a database to generate data applied in determining the patent license fee data; and
outputting on the computer the patent license fee data.

14. The method according to claim 13, wherein the query-generated data include licensor patent data.

15. The method according to claim 13, wherein the query-generated data include licensee revenue data.

16. The method according to claim 13, wherein the query-generated data include licensee affiliate data.

17. The method according to claim 13, wherein the query-generated data include licensee patent data.

18. The method according to claim 13, wherein the input data include the licensee identity as the sole manual input.

19. The method according to claim 13, wherein the input data include a licensor identity.

20. The method according to claim 13, wherein the input data include a license type.

21. The method according to claim 13, wherein the input data include a technological field.

22. The method according to claim 13, wherein the input data include a plurality of licensee identities.

23. The method according to claim 13, wherein the patent license fee data include a plurality of rank-ordered license fees.

24. The method according to claim 13, wherein the database query is conducted over a local area network.

25. The method according to claim 13, wherein the database query is conducted over a wide area network.

26. A computer, comprising:
a user interface; and
a processor;
characterized in that the computer receives input data including a licensee identity on the user interface, processes the input data using the processor to determine patent license fee data, and transmits the patent license fee data on the user interface.

27. The computer according to claim 26, further comprising a network interface and further characterized in that the computer, in response to the input data, queries a database using the network interface to generate data applied in determining the patent license fee data.
